(19) United States
(12) Patent Application Publication
(10) Pub. No.: US 2016/0280586 A1
(43) Pub. Date: Sep. 29, 2016

(54) GLASS

(71) Applicant: UNIVERSITY OF LEEDS, Leeds (GB)

(72) Inventors: Animesh JHA, Leeds (GB); Billy Donald Orac RICHARDS, Leeds (GB)

(73) Assignee: University of Leeds, Leeds (GB)

(21) Appl. No.: 14/778,242

(22) PCT Filed: Mar. 19, 2014
(86) PCT No.: PCT/GB2014/050865

§ 371 Date: Sep. 18, 2015

(30) Foreign Application Priority Data
Mar. 20, 2013 (GB) 1305059.6

(51) Int. Cl. C03C 3/253; H01S 3/16; C09K 11/88; H01S 3/17; C03C 3/12; C03C 4/12

(52) U.S. Cl. CPC C03C 3/253; C03C 3/122; C03C 4/12; C09K 11/886; H01S 3/177; H01S 3/17; H01S 3/1606; C03C 2204/00

(57) ABSTRACT

The present invention relates to a dysprosium-doped tellurite or germanate glass characterised by a fluorescence peak in the mid-IR spectrum.

The present invention relates to a dysprosium-doped tellurite or germanate glass characterised by a fluorescence peak in the mid-IR spectrum, to a laser assembly comprising a gain medium composed of the dysprosium-doped tellurite or germanate glass and to the use of the dysprosium-doped tellurite or germanate glass as (or in) a phosphor or as a gain medium.

Mid-IR lasers and sources in the 3-4 μm range are desirable for various applications, in particular those exploiting the 3-5 μm atmospheric absorption window such as long-range free-space, spectroscopy, sensing and LIDAR. Silica fibres are extremely robust and widely used in the near-IR but a high phonon energy of 1100 cm⁻¹ precludes the use of silica glass at wavelengths longer than around 2.3 μm due to its multiphonon absorption edge. The low phonon energy of around 550 cm⁻¹ of ZBLAN glass (so called because it contains fluorides of Zr, Ba, La, Al and Na) has enabled it to be extensively exploited as a laser host material for sources in the mid-IR using various rare earth ions such as Ho³⁺ at 2.9 μm and 3.9 μm, Er³⁺ at 2.8 μm and Dy³⁺ at 2.96 μm. However the relative fragility and inferior glass stability of ZBLAN fibres limits their usefulness for certain important applications. Moreover the output of Dy³⁺ doped ZBLAN fibre lasers at 2.9 μm coincides with strong water absorptions.

Tellurite and germanate glasses are more stable than fluoride glass as shown by their higher T_{g} and Tₓ-T_{g} values. This makes them more desirable for industrial laser applications. Tellurite and germanate glasses are based on the glass formers TeO₂ and GeO₂ and have phonon energies in the ranges 650-800 cm⁻¹ and 900 cm⁻¹ respectively. The infrared transmission range of tellurite glass is commonly quoted to be up to around 5 μm. However fluorescence has never been demonstrated at wavelengths longer than around 3 μm in a rare earth doped oxide glass.

The present invention is based on the recognition that certain dysprosium (Dy³⁺ )-doped tellurite and germanate glasses exhibit a broad mid-IR fluorescence peak.

Thus viewed from a first aspect the present invention provides a dysprosium-doped tellurite or germanate glass which exhibits a fluorescence peak attributable to the ⁶H_{13/2} to ⁶H15/2 transition in the mid-IR spectrum.

The fluorescence peak attributable to the ⁶H_{13/2} to ⁶H_{15/2} transition in the dysprosium-doped tellurite or germanate glasses of the invention compared with the fluorescence peak attributable to the same transition in conventional dysprosium-doped materials is advantageously red-shifted to the mid-IR spectrum. This presents opportunities for the development of long wavelength systems for sources and power delivery in applications as diverse as security, chemical, environmental, sensing and medical applications. The mid-IR fluorescence from the dysprosium-doped tellurite or germanate glasses of the invention is non-coincident with strong water absorptions and will be less attenuated in the atmosphere than the fluorescence radiation from conventional dysprosium-doped materials.

In a dysprosium-doped tellurite glass, the host is predominantly a Te—O network. In a dysprosium-doped germanate glass, the host is predominantly a Ge—O network. In either case, the host may be a mixed Te—O and Ge—O network.

Typically the dysprosium-doped tellurite or germanate glass exhibits dysprosium absorption bands in the range 800 to 2800 nm.

Preferably the dysprosium-doped tellurite or germanate glass exhibits dysprosium absorption bands attributable to transitions from ⁶H₁₉₂ to at least two or more (preferably all) of the group consisting of ⁶H_{13/2}, ⁶H_{11/2}, ⁶H_{9/2} & ⁶F_{11/2}, ⁶H_{7/2} & ⁶F_{9/2}, ⁶F_{7/2} and ⁶F_{5/2}.

Preferably the dysprosium-doped tellurite or germanate glass exhibits a dysprosium absorption band attributable to the ⁶H_{15/2} to ⁶F_{5/2} transition at a wavelength in the range 780 to 1000 nm, particularly preferably 780 to 820 nm (eg about 800 nm) or 960 to 1000 nm (eg about 980 nm).

Typically the dysprosium-doped tellurite or germanate glass exhibits an absorption coefficient spectrum substantially as illustrated in FIG. 2.

Preferably the dysprosium-doped tellurite or germanate glass exhibits a fluorescence peak attributable to the ⁶H_{13/2} to ⁶H_{15/2} transition in the range 3000 to 4000 nm, preferably 3200 to 3700 nm, more preferably 3300 to 3500 nm (eg about 3400 nm).

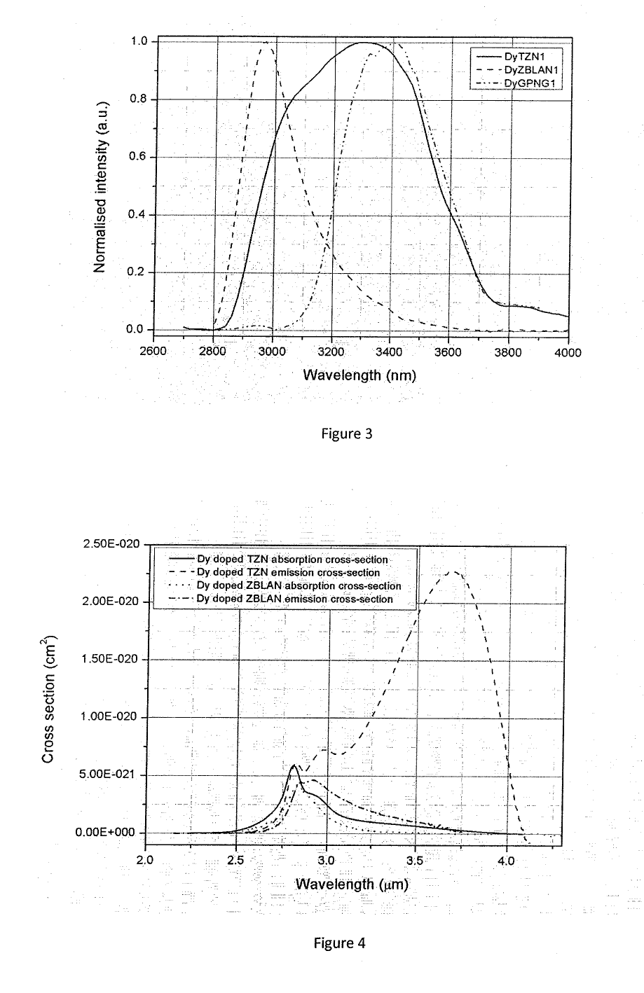

Typically the dysprosium-doped tellurite or germanate glass exhibits a fluorescence peak attributable to the ⁶H_{13/2} to ⁶H_{15/2} transition substantially as illustrated in FIG. 3.

Preferably the tail of the fluorescence peak attributable to the ⁶H_{13/2} to ⁶H_{15/2} transition extends over 4000 nm.

Preferably the FWHM of the fluorescence peak attributable to the ⁶H_{13/2} to ⁶H_{15/2} transition is in excess of 250 nm, particularly preferably in excess of 300 nm, more preferably in excess of 350 nm.

The surprising breadth of the fluorescence peak attributable to the ⁶H_{13/2} to ⁶H_{15/2} transition is useful for maximising the tunability of the dysprosium-doped tellurite or germanate glass when it is used as a gain medium and facilitates the generation of laser pulses of short duration.

Preferably the emission cross-section of the peak attributable to the ⁶H_{13/2} to ⁶H_{15/2} transition is 5×10⁻²¹cm² or more (e.g. at about 3700 nm), particularly preferably 1×10⁻²⁰ cm² or more (e.g. at about 3700 nm).

The surprisingly high emission cross-section is useful for maximising the optical gain of the dysprosium-doped tellurite or germanate glass when it is used as a gain medium.

Preferably the peak of the emission cross-section attributable to the ⁶H_{13/2} to ⁶H_{15/2} transition is in the range 3500 to 4000 nm, particularly preferably 3600 to 3800 nm (eg about 3700 nm).

Typically the dysprosium-doped tellurite or germanate glass exhibits an emission cross-section attributable to the ⁶H_{13/2} to ⁶H_{15/2} transition substantially as illustrated in FIG. 4.

In comparison with (for example) fluoride glasses, the fluorescence lifetime of Dy³⁺ ion dopants is exceptionally long in the tellurite or germanate glasses of the invention. This is useful for their use as a gain medium in an efficient laser.

The fluorescence lifetime of the ⁶H_{13/2} energy level is typically 0.01 seconds or more, preferably 0.1 seconds or more, particularly preferably 1 second or more, more preferably 5 seconds or more.

Without wishing to be bound by theory, the surprisingly lengthy fluorescence decay of the ⁶H_{13/2} to the ⁶H_{15/2} transition may be attributable to a phosphorescent process. The presence of electronic defects caused by partial vacancies in the tellurium/germanium and oxygen lattice may lead to the formation of defect states which cause phosphorescence.

The surprisingly lengthy fluorescence decay of the ⁶H_{13/2} to the ⁶H_{15/2} transition is useful for minimising the threshold of the dysprosium-doped tellurite or germanate glass (and therefore maximising its efficiency) when it is used as a gain medium and also facilitates the generation of higher energy pulses.

The persistent fluorescence of the dysprosium-doped tellurite or germanate glass may be advantageous for its use as (or in) a phosphor. A phosphor in the mid-IR range may be useful to replace everyday light bulbs which have poor photon efficiency and may be useful in spectroscopy.

Typically the dysprosium-doped tellurite or germanate glass exhibits one or more fluorescence peaks in the near-IR spectrum (eg in the range 800 to 2500 nm). Preferably the dysprosium-doped tellurite or germanate glass exhibits one or more fluorescence peaks in the range 1200 to 2000 nm.

Preferred is a dysprosium-doped tellurite glass.

Preferred is a dysprosium-doped germanate glass.

The dysprosium-doped tellurite or germanate glass may include a co-dopant. The co-dopant may exhibit an absorption band in the range 900 to 1100 nm, preferably 950 to 1050 nm. The inclusion of a co-dopant may improve efficiency (eg by enhancing the population build-up rate of upper levels by cross-relaxation) and may improve access to conventional excitation lasers (eg by acting as a sensitizer ion).

A preferred co-dopant is Yb, Er, Tm, Bi or Ho.

The dysprosium-doped tellurite or germanate glass may be obtainable from a glass composition of oxides and/or halides (eg fluorides).

The dysprosium-doped tellurite or germanate glass may be obtainable by melt-quenching the glass composition of oxides and/or halides (eg fluorides).

Preferably the dysprosium-doped tellurite or germanate glass is obtainable by melt-quenching a glass composition of oxides and/or halides in the presence of a gas flow (eg a bubbling gas). The gas flow advantageously serves to minimise the presence of hydroxyl ions and/or water. Typically the gas flow is a dry gas flow.

Preferably the dysprosium-doped tellurite or germanate glass has an OH content of 50 ppm or less, particularly preferably 10 ppm or less.

The gas flow may be an inert gas flow. The gas flow may be an oxygen flow.

The gas flow may be a flow of reactive gas (eg a reactive gas which reacts with hydroxyl ions and/or water). The flow of reactive gas may be a chlorine or fluorine flow.

In a preferred embodiment, the gas flow is a flow of at least one of chlorine, fluorine or oxygen. Particularly preferably the flow of chlorine, fluorine or oxygen is dried (eg is substantially water-free).

Typically GeO₂ is the predominant oxide in the glass composition of oxides and/or halides.

The amount of GeO₂ in the glass composition of oxides and/or halides may be 40 mol % or more, preferably in the range 50 to 80 mol %, particularly preferably 55 to 70 mol %.

Typically TeO₂ is the predominant oxide in the glass composition of oxides and/or halides. The amount of TeO₂ in the glass composition of oxides and/or halides may be 40 mol % or more, preferably in the range 60 to 90 mol %, particularly preferably 65 to 85 mol % (eg about 80 mol %).

TeO₂ and GeO₂ may be the predominant oxides in the glass composition of oxides and/or halides. The amount of TeO₂ and GeO₂ in the glass composition of oxides and/or halides may be 40 mol % or more, preferably in the range 50 to 90 mol %, particularly preferably 55 to 85 mol % (eg about 80 mol %).

The glass composition of oxides and/or halides may comprise one or more (preferably a plurality of) network modifiers. The (or each) network modifier may be a metal oxide or metal halide (preferably fluoride). Preferably the (or each) network modifier is a metal oxide.

The total amount of network modifier in the glass composition of oxides and/or halides may be 60 mol % or less, preferably 40 mol % or less, particularly preferably 20 mol % or less.

The amount of each network modifier in the glass composition of oxides and/or halides may be up to 30 mol %, preferably up to 20 mol %, particularly preferably up to 10 mol %.

In a preferred embodiment of a dysprosium-doped tellurite glass, the total amount of network modifier in the glass composition of oxides and/or halides is in the range 5 to 20 mol %.

In a preferred embodiment of a dysprosium-doped germanate glass, the total amount of network modifier in the glass composition of oxides and/or halides is in the range 1 to 31 mol %.

The (or each) network modifier may be an oxide of Ba, Bi, Pb, Zn, Al, Ga, La, Nb, W, Ta, Zr, Ti or V.

Preferably the (or each) network modifier is selected from the group consisting of BaO, Bi₂O₃, PbO, PbF₂, ZnO, ZnF₂, Ga₂O₃, Al₂O₃, La₂O₃, Nb₂O₅, WO₃, Ta₂O₅, ZrO₂, TiO₂ and V₂O₅.

The glass composition of oxides and/or halides may comprise MgO, CaO, SrO, BaO, ZnO, PbO or a mixture thereof. The amount of MgO, CaO, SrO, BaO, ZnO, PbO or mixture thereof in the glass composition of oxides and/or halides may be 30 mol % or less, preferably 20 mol % or less, particularly preferably 10 mol % or less. The MgO, CaO, SrO, BaO, ZnO, PbO or mixture thereof may be a network modifier.

Preferably the glass composition of oxides and/or halides comprises one or more alkali metal oxides. The (or each) alkali metal oxide may be a network modifier. The amount of alkali metal oxides in the glass composition of oxides and/or halides may be 25 mol % or less, preferably 20 mol % or less, particularly preferably 10 mol % or less.

Preferably the glass composition of oxides and/or halides comprises one or more alkali metal halides (preferably fluorides). The (or each) alkali metal halide may be a network modifier. The amount of alkali metal halides in the glass composition of oxides and/or halides may be 25 mol % or less, preferably 20 mol % or less, particularly preferably 10 mol % or less.

Preferably the glass composition of oxides and/or halides comprises one or more of Li₂O, Na₂O, K₂O or a mixture thereof.

Preferably the glass composition of oxides and/or halides comprises one or more metal halides. The one or more metal halides may be selected from the group consisting of BaCl₂, PbCl₂, PbF₂, LaF₃, ZnF₂, BaF₂, NaCl, NaF, LiF and mixtures thereof. The amount of the one or more metal halides in the glass composition of oxides and/or halides may be 20 mol % or less. Preferred metal halides are PbF₂ and ZnF₂.

The glass composition of oxides and/or halides may comprise an alkali metal or alkaline earth metal phosphate.

The glass composition of oxides and/or halides may comprise an enhancing compound. The enhancing compound may be an oxide of phosphorous or boron. Preferably the enhancing compound is P₂O₅, B₂O₃ or a mixture thereof.

The glass composition of oxides and/or halides may comprise dysprosium oxide or dysprosium halide (eg fluoride).

The glass composition of oxides and/or halides may comprise an oxide or halide of a co-dopant.

Preferably the amount of dysprosium oxide or halide in the glass composition of oxides and/or halides is in excess of 1 wt %, particularly preferably 1.5 wt % or more, more preferably 2.0 wt % or more, even more preferably 3 wt % or more, yet more preferably 5 wt % or more.

The amount of any oxide or halide of a co-dopant in the glass composition of oxides and/or halides may be 0.5 wt % or more, preferably 1.0 wt % or more, particularly preferably 2.0 wt % or more, more preferably 3 wt % or more, yet more preferably 5 wt % or more.

In a preferred embodiment of the dysprosium-doped tellurite or germanate glass, the amount of dysprosium oxide or halide in the glass composition of oxides and/or halides is in excess of 1 wt %.

In a preferred embodiment the dysprosium-doped tellurite or germanate glass is in the form of a spatially inhomogeneous structure.

The spatially inhomogeneous structure may be a waveguide. The waveguide may guide light in one dimension (eg vertically) or two dimensions. The waveguide may be a fiber (or a core thereof), channel, planar or slab waveguide. The waveguide may be electrically or optically pumpable.

In a preferred embodiment the spatially inhomogeneous structure is a channel waveguide. Particularly preferably the dysprosium-doped tellurite or germanate glass is laser-inscribed to form a channel waveguide. The dysprosium-doped tellurite or germanate glass may be laser-inscribed by a femtosecond pulsed laser.

Viewed from a further aspect the present invention provides a laser assembly comprising:
a gain medium composed of a dysprosium-doped tellurite or germanate glass as hereinbefore defined;
an exciter upstream from the gain medium and capable of exciting the gain medium into a mid-IR output; and
a mechanism optically associated with the gain medium to provide optical feedback in the gain medium.

Preferably the laser assembly further comprises a detector downstream from and capable of detecting the output from the gain medium.

Preferably the laser assembly further comprises a collector downstream from and capable of collecting the output from the gain medium.

Preferably the exciter is a source of electromagnetic radiation. For example, the exciter may be a diode laser or light emitting diode (LED or SLED). The exciter may be a semiconductor laser. For example, the exciter may be a vertical cavity surface emitting laser (VCSEL). The exciter may be a continuous wave laser. The exciter may be a pump laser.

Viewed from a yet further aspect the present invention provides the use of a dysprosium-doped tellurite or germanate glass as hereinbefore defined as or in a phosphor or as a gain medium.

Viewed from an even yet further aspect the present invention provides a process for preparing a dysprosium-doped tellurite or germanate glass by melt-quenching a glass composition of oxides and/or halides as hereinbefore defined in the presence of a gas flow.

The gas flow may be as hereinbefore defined.

Embodiments of the invention will now be described in detail and by way of example only with reference to the accompanying drawings in which:

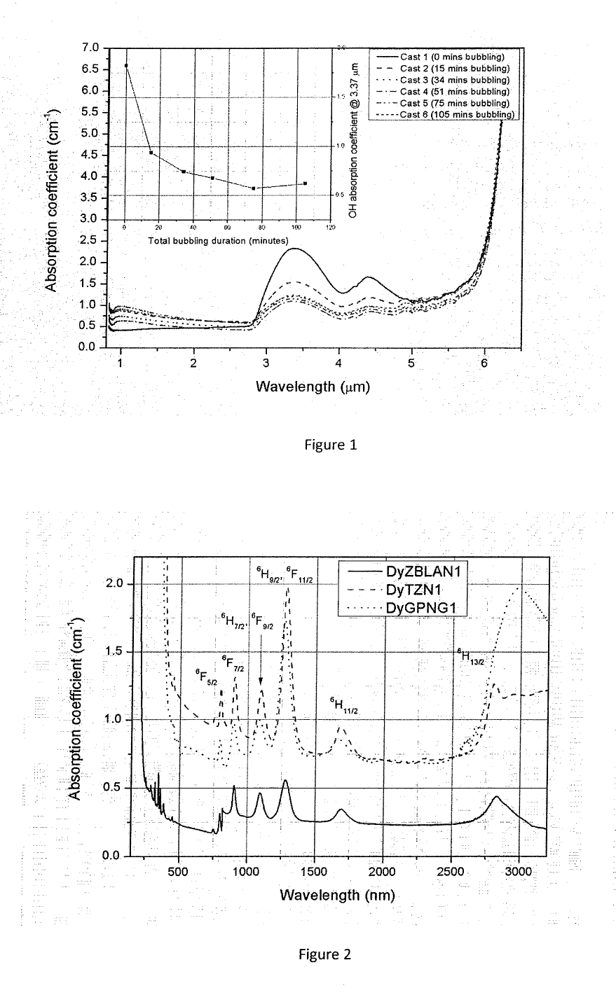

FIG. 1: The FTIR absorption coefficient spectra of TZN tellurite glasses fabricated with varying durations of O₂ bubbling;

FIG. 2: The absorption coefficient spectra of DyTZN1 and DyZBLAN1. The absorption bands are attributed to absorption from the Dy³⁺:⁶H_{15/2} ground state to the labelled excited state energy level;

FIG. 3: Normalized mid-IR fluorescence spectra of DyTZN1, DyGPNG1 and DyZBLAN1 glass samples when excited using an 808 nm laser diode source;

FIG. 4: Absorption and emission cross-section spectra of DyTZN1 and DyZBLAN1 glass samples. The absorption cross-section data is derived from the measured absorption coefficient spectra and the McCumber theory is used to calculate the emission cross-section data;

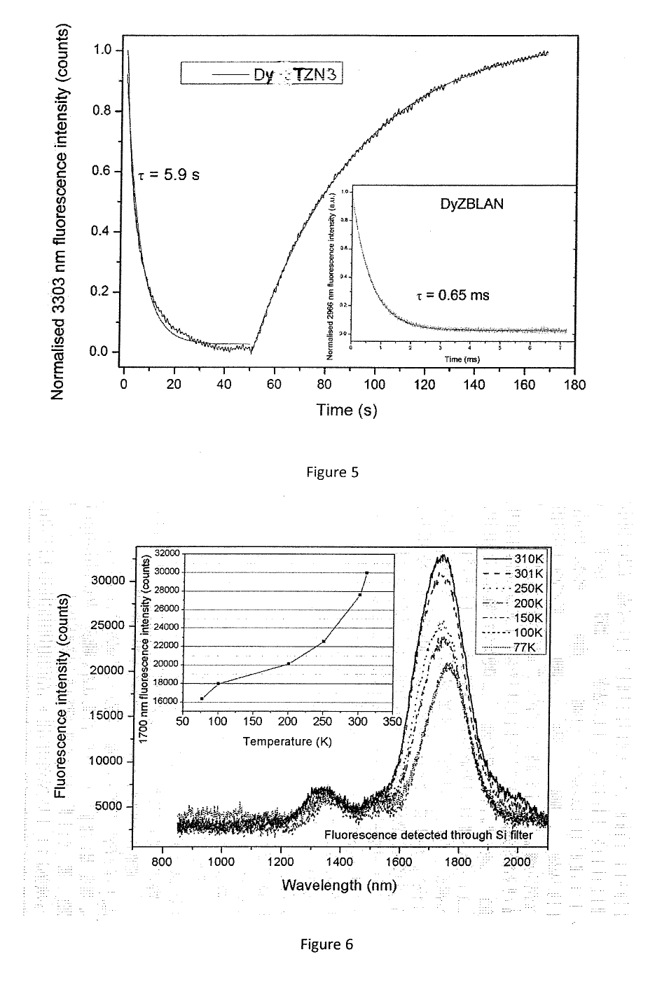

FIG. 5: Fluorescence decay and rise curve of a DyTZN3 sample when excited using a modulated 808 nm laser diode source. The inset shows the fluorescence decay curve of the DyZBLAN1 glass using the same excitation source;

FIG. 6: Near-IR fluorescence spectra of Dy³⁺ doped tellurite glass (DyTZN3) as a function of temperature;

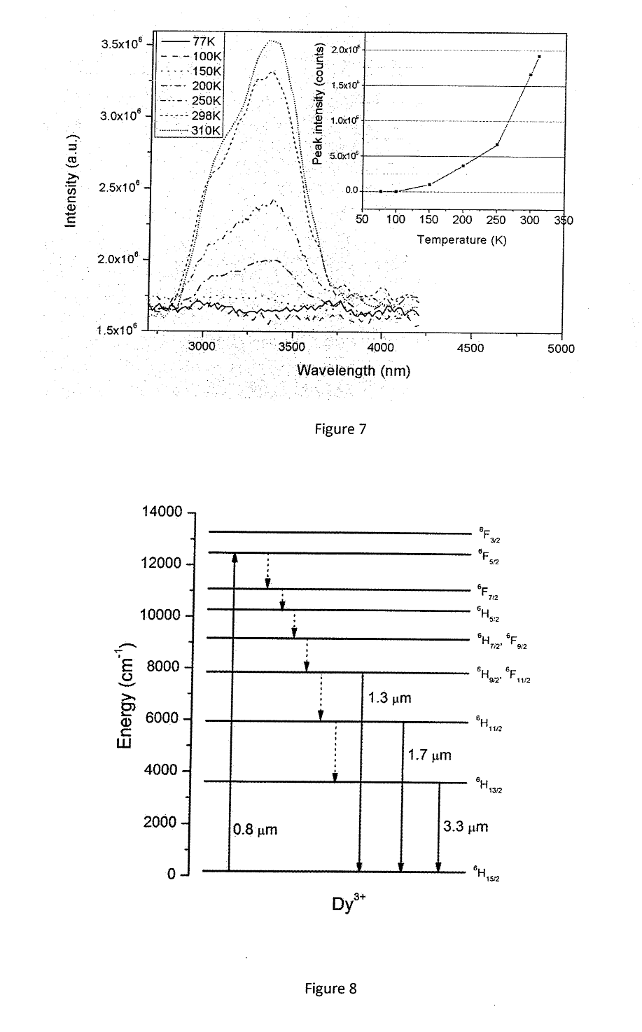

FIG. 7: Mid-IR fluorescence spectra of Dy³⁺ doped tellurite glass (DyTZN3) as a function of temperature;

FIG. 8: The energy level diagram of Dy³⁺ (solid and dashed lines represent radiative and non-radiative transitions respectively);

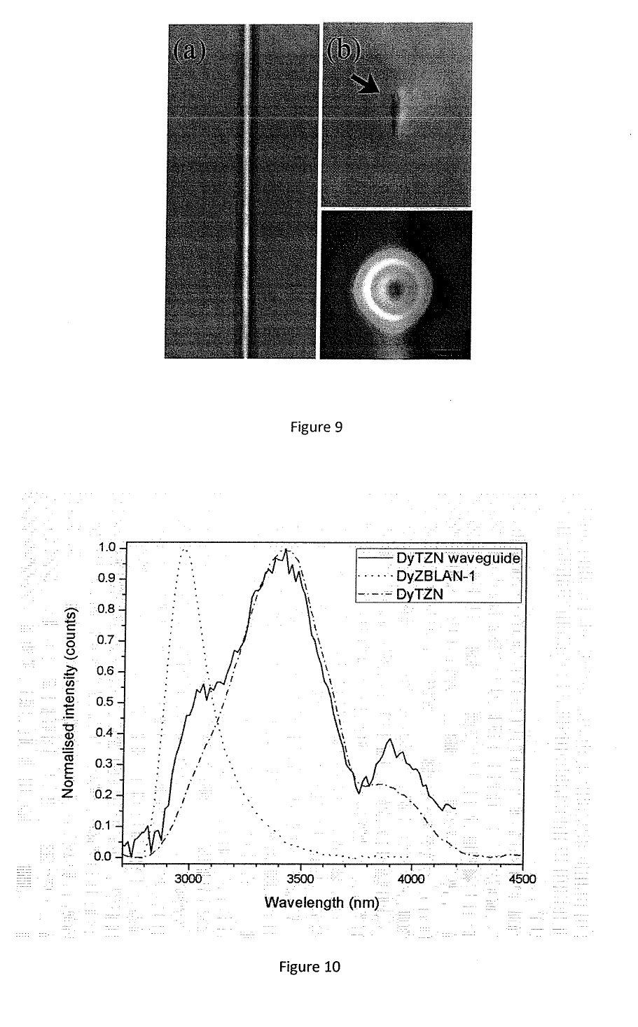

FIG. 9: (a) The DIC image of the waveguide (fs-laser beam normal to the paper) (b) The DIC image of the transverse section of the waveguide (arrow shows the guiding region) and (c) The 1600 nm output mode from the waveguide; and

FIG. 10: The normalized ASE spectrum of a Dy³⁺ doped tellurite waveguide compared to the spontaneous fluorescence spectra of Dy³⁺ doped tellurite and ZBLAN bulk glass samples.

### EXAMPLE

1. Experimental

Glass samples for spectroscopy and laser inscription were fabricated using the melt-quench technique discussed in Jha et al. Review on structural, thermal, optical and spectroscopic properties of tellurium oxide based glasses for fibre optic and waveguide applications. Int. Mater. Rev. 2012. The precursor oxide and fluoride chemicals had a purity of ≧99.99% and were batched and then melted in electric tube furnaces. The glass compositions of this Example are listed in Table 1. Tellurite and ZBLAN glasses were melted at 750° C. in gold crucibles in an atmosphere of flowing O₂ (2 1/min) which had passed through a chiller and gas purification cartridge to remove moisture and other contaminants such as CO₂. Germanate glasses were melted at 1200° C. in a platinum crucible also in a dry O₂ atmosphere as described for the tellurite glasses. Glass melts were cast into brass moulds which had been preheated and were then annealed close to the glass transition temperature for 3 hours before being cooled to room temperature at a rate of ≦1° C./min. The glasses were then polished to an optical finish ready for spectroscopic characterisation.

Absorption spectra of the glasses were measured using Perkin Elmer Lambda 19 UV-vis-NIR and Bruker Vertex 70 FTIR spectrometers. The Dy³⁺ fluorescence spectra were measured using an Edinburgh Instruments FLS920 steady-state and time resolved fluorescence spectrometer fitted with a liquid nitrogen-cooled InSb photo-detector for mid-IR wavelengths and an InGaAs photo-detector for near-IR wavelengths. Samples were excited using a 4.5 W, 808 nm laser diode source and germanium and silicon filters were placed between the sample and the emission monochromator for mid-IR and near-IR fluorescence measurements respectively. Cryogenic measurements were carried out using an Oxford Instruments cryostat.

TABLE 1
Glass Compositions

| Sample ID | Composition |
|---|---|
| DyTZN1 | 80TeO₂—10ZnO—10Na₂O (mol %) + 1 wt % Dy₂O₃ |
| DyTZN3 | 80TeO₂—10ZnO—10Na₂O (mol %) + 3 wt % Dy₂O₃ |
| DyZBLAN1 | 53ZrF₄—20BaF₂—3.5LaF₃—3.5AlF₃—20NaF—1DyF₃ |
| | (mol %) |
| DyGPNG1 | 56GeO₂—31PbO—9Na₂O—4Ga₂O₃ + 1 wt % Dy₂O₃ |

The bottom level transition of Dy³⁺ ions in glass is resonant with Te—OH bond stretching absorption bands. Thus for laser operation to be viable from this transition in oxide glass, it is desirable that OH⁻ contamination is minimized. There are several techniques which can be used during glass fabrication to minimize OH⁻ ion content. These include fluorination and gas bubbling. The addition of up to 15 mol % of ZnF₂ in tellurite glass has been demonstrated to virtually eliminate OH⁻ absorption in the mid-IR resulting in glasses with low loss whist maintaining glass stability. Similarly Off absorption has been demonstrated to be drastically reduced in germanate glass with the inclusion of PbF₂ in the glass batch. Fluorides in the glass batch react with bonded OH⁻ groups and atmospheric H₂O to produce HF gas which is ejected from the glass melt. Bubbling glass melts with non-reactive and reactive gases such as dry O₂ and Cl₂ respectively helps to remove OH⁻ and free-water contamination. Non-reactive gases such as O₂ remove OH⁻ by reaching equilibrium between the OH⁻ in the glass and the H₂O in the gas bubble. Thus it is important that steps are taken to ensure that the gas used to bubble the glass melt is as dry as possible. A reactive gas such as Cl₂ is most effective as it reacts with OH⁻ and H₂O in the glass to form HCl gas.

FIG. 1 shows the FTIR absorption spectra of a range of tellurite glasses which were bubbled with O₂ gas for varying durations. The inset graph shows the variation of the peak OH⁻ absorption band at 3.37 μm as a function of O₂ gas bubbling duration. The peak absorption coefficient of the Off band at 3.37 μm can be clearly seen to reduce during the first 75 minutes of bubbling until equilibrium is reached with the H₂O content of the gas. Further OH⁻ reduction can be achieved by combining fluorination with reactive gas bubbling.

2. Results and discussion

Absorption coefficient

FIG. 2 compares the absorption coefficient spectra of DyTZN1, DyGPNG1 and DyZBLAN1 glasses. The glass samples exhibit Dy³⁺ absorption bands at 2800 nm, 1690 nm, 1280 nm, 1100 nm, 900 nm and 800 nm due to transitions from the ⁶H_{15/2} ground state to the ⁶H_{13/2}, ⁶H_{11/2}, ⁶H_{9/2} & ⁶F_{11/2}, ⁶H_{7/2} & ⁶F_{9/2}, ⁶F7/2 and ⁶F_{5/2} energy levels respectively. The 800 nm absorption band of Dy³⁺ coincides with widely available, high power laser diode sources which can be used to pump Dy³⁺ doped devices. However it is desirable to pump with longer wavelength sources in order to reduce the quantum defect. The ⁶H_{13/2} absorption band in the DyGPNG1 samples appears more intense that the other samples. However this absorption peak is also partly due to OH⁻ absorption in the sample which had not undergone optimized drying. Currently diode laser sources operating at longer wavelengths which coincide with Dy³⁺ absorption bands are not widely available but codoping with Yb³⁺ for example may enable the use of ˜980 nm laser diode pumping. In ZBLAN glass, there are several Dy³⁺ absorption bands in the range 290-450 nm. However in TZN glass, these are mostly obscured by the electronic absorption edge of the glass.

Room Temperature Fluorescence

Fluorescence from the ⁶H_{13/2}→⁶H_{15/2} bottom level transition of Dy³⁺ was detected in the ZBLAN, TZN and GPNG samples when an 808 nm laser diode was used to excite the ⁶F_{5/2} energy level. FIG. 3 compares the fluorescence spectra of the various Dy³⁺ doped glass samples and shows that in the oxide glasses the fluorescence is red shifted to a peak value of 3.3-3.4 μm compared to 2.95 μm in ZBLAN glass. The FWHM of the ⁶H_{13/2}→⁶H_{15/2} fluorescence peak is larger in TZN glass (500 nm) and germanate glass (380 nm) than in the ZBLAN glass (223 nm) and also extends to up to 4 μm at the long wavelength tail. Based on the absorption spectra of Dy³⁺ doped TZN and ZBLAN glass, the absorption cross section has been calculated and used to determine the emission cross section using the McCumber theory. FIG. 4 compares the absorption and emission cross sections of Dy³⁺ doped into TZN and ZBLAN glasses and shows that in a tellurite glass, the emission cross section is much broader and shifted to longer wavelengths. This is similar to the measured spontaneous fluorescence spectra shown in FIG. 3. The peak emission cross-section of the Dy³⁺:⁶H_{13/2}→⁶H_{15/2} transition is also much larger in tellurite glass (2.3×10⁻²⁰ cm² at 3.7 μm) than in ZBLAN glass (4.6×10⁻²¹ cm² at 2.9 μm) which is beneficial for laser operation.

The lifetime of the Dy³⁺:⁶H_{13/2} energy level in tellurite and fluoride glass hosts was measured by modulating the output of the 808 nm laser diode and recording the decay of the detector signal with the monochromator set to the peak fluorescence wavelength (ie 2.95 μm for fluoride glass and 3.4 μm for tellurite glass). FIG. 5 compares the normalized fluorescence decay of the Dy³⁺:⁶H_{13/2} energy level in the tellurite and fluoride glasses showing a lifetime of 650 μs in fluoride glass compared to around 5.9 seconds in tellurite glass. The exact same experimental set-up and detector was used for the lifetime measurements of both the tellurite and ZBLAN samples. The slow rise- and fall-times at 3.4 μm in tellurite glass suggest that relaxation to the ⁶H_{13/2} level is the rate-limiting step. Codoping may be advantageous for enhancing the population build-up rate of the upper-laser level through cross-relaxation processes. Another route to enhance the population of the ⁶H_{13/2} level may be to use a longer wavelength pump source and a sensitizer ion to excite the ⁶H_{13/2} upper laser level directly. The decay mechanism of Dy³⁺ ions in tellurite glass appears to be a room temperature, mid-IR, phosphor-like phenomenon resulting in very long upper level lifetimes.

Similar measurements carried out on a tellurite glass of a different composition gave the following results:

80 TeO₂−10 ZnO−8 Na₂O−2 NaF (mol %)+5 wt % Dy₂O₃=14.3 s

69 TeO₂−23 WO₃−8 La₂O₃+3 wt % Dy₂O₃=10.8 s

Cryogenic Fluorescence

Fluorescence measurements were carried out on the DyTZN3 sample using an 808 nm laser diode excitation source at cryogenic temperatures to better understand the energy transfer mechanisms involved. FIGS. 6 and 7 show the fluorescence results of the ˜1.7 μm Dy³⁺:⁶H_{11/2}→⁶H_{15/2} and ˜3.3 μm Dy³⁺:⁶H_{13/2}→⁶H_{15/2} transitions respectively. The fluorescence intensity from both the Dy3+:⁶H_{11/2}→⁶H_{15/2} and ⁶H_{13/2}→⁶H_{15/2} transitions reduces with decreasing temperature. This suggests that at low temperatures, the population at the ⁶H_{11/2} and ⁶H_{13/2} energy levels is diminished and emission is occurring through a more temperature sensitive route which appears to be determining the mid-IR phosphor like behaviour observed in the room-temperature data. FIG. 6 also shows that the intensity of the 1.3 μm fluorescence band does not significantly change with temperature. Exciting Dy³⁺ ions at 808 nm requires several non-radiative, phonon assisted decay processes in order to populate the ⁶H_{9/2} and ⁶F_{11/2}, ⁶H_{11/2} and ⁶H_{13/2} energy levels (as exemplified in the energy level diagram in FIG. 8). Reduced phonon coupling at low temperatures reduces the population at the ⁶H_{9/2} and ⁶F_{11/2}, ⁶H_{11/2} and ⁶H_{13/2} levels and is likely to result in increased radiative decay from the ⁶F_{5/2} pump level. The fact that the 1.3 μm fluorescence intensity does not reduce at low temperatures is likely to be due to the fact that decay to the ⁶H_{9/2} and ⁶F_{11/2} levels occurs via a sequence of single-phonon steps, whilst decay to lower energy levels requires larger energy, multi-phonon steps (the likelihood of which decreases more quickly with decreasing temperature). Under 808 nm pumping, very little visible fluorescence from ESA or upconversion was detected in TZN glass. As can be seen in FIG. 2, the upper level of Dy³⁺ (⁴F_{9/2} from which visible transitions occur) is resonant with the electronic band edge of TZN glass reducing the probability of radiative transitions from this level.

Dy³⁺ doped tellurite waveguide characterisation

Channel waveguides were inscribed using a femtosecond laser operating at 800 nm, 1 kHz repetition rate and 100 fs pulse width using the inscription process described by Fernandez TT et al. Femtosecond laser written optical waveguide amplifier in phospho-tellurite glass. Opt Express. 2010 Sep. 13; 18(19):20289-97. Laser inscription was carried out with a 0.65 NA aspheric lens objective with various powers ranging from 300 nJ to 5 μJ and speeds from 0.01-6 mm/s.

FIG. 9(a) shows the differential interference contrast (DIC) microscope image of the waveguide written with 500 nJ pulse energy and 0.025 mm/s translation speed. FIG. 9(b) shows the waveguide cross section and indicates a strong negative index region at the centre with a positive index region on its top left (marked by arrow). A 1600 nm laser mode was propagated through the channels (FIG. 9(c)) to ensure guidance. The refractive index change was calculated to be around 6×10⁻³.

A fibre pigtailed 808 nm laser diode source was butt-coupled to obtain the amplified spontaneous emission (ASE) from the waveguide and the resulting spectrum is displayed in FIG. 10 compared with the spontaneous fluorescence from bulk Dy³⁺ doped tellurite and ZBLAN glass samples. The mid-IR ASE spectrum of the Dy³⁺ tellurite waveguide largely matches the line shape of the spontaneous fluorescence from bulk Dy³⁺ tellurite glass with the exception of slightly enhanced intensity around 3 μm and 3.9 μm. This suggests potential enhancements in the bandwidth of this transition in waveguiding structures which is important for future waveguide and fibre laser applications.

Conclusions

Dy³⁺ doped heavy-metal oxide tellurite and germanate glasses and waveguides exhibit broader and red-shifted fluorescence from the ⁶H_{13/2}→⁶H_{15/2} transition compared to the current standard mid-IR laser glass ZBLAN. Dy³⁺ doped ZBLAN fibre lasers have previously been demonstrated to operate at ˜2.95 μm which coincides with the strong absorption of water. This makes them inappropriate for atmospheric applications such as sensing and LIDAR. A laser based on Dy³⁺ doped tellurite waveguide or fibre could potentially operate at longer wavelengths up to around 3.3 μm or beyond which is within the atmospheric transmission window. Tellurite and germanate glasses are also more robust and stable than ZBLAN glass which makes them more desirable in industrial applications.

1. A dysprosium-doped tellurite or germanate glass which exhibits a fluorescence peak attributable to the ⁶H_{13/2} to ⁶H_{15/2} transition in the mid-IR spectrum.

2. The dysprosium-doped tellurite or germanate glass as claimed in claim 1, which exhibits a dysprosium absorption band attributable to the ⁶H_{15/2} to ⁶F_{5/2} transition at a wavelength in the range 780 to 1000 nm.

3. The dysprosium-doped tellurite or germanate glass as claimed in claim 1, which exhibits a fluorescence peak attributable to the ⁶H_{13/2} to ⁶H_{15/2} transition in the range 3300 to 3500 nm.

4. The dysprosium-doped tellurite or germanate glass as claimed in claim 1, wherein the tail of the fluorescence peak attributable to the ⁶H_{13/2} to ⁶H_{15/2} transition extends over 4000 nm.

5. The dysprosium-doped tellurite or germanate glass as claimed in claim 1, wherein the FWHM of the fluorescence peak attributable to the ⁶H_{13/2} to ⁶H_{15/2} transition is in excess of 250 nm.

6. The dysprosium-doped tellurite or germanate glass as claimed in claim 1, wherein the emission cross-section of the peak attributable to the ⁶H_{13/2} to ⁶H_{15/2} transition is 5−10⁻²¹cm² or more.

7. The dysprosium-doped tellurite or germanate glass as claimed in claim 1, wherein the peak of the emission cross-section attributable to the ⁶H_{13/2} to ⁶H_{15/2} transition is in the range 3600 to 3800 nm.

8. The dysprosium-doped tellurite or germanate glass as claimed in claim 1, wherein the fluorescence lifetime of the ⁶H_{13/2} energy level is 5 seconds or more.

9. The dysprosium-doped tellurite or germanate glass as claimed in claim 1, which exhibits one or more fluorescence peaks in the range 1200 to 2000 nm.

10. The dysprosium-doped tellurite or germanate glass as claimed in claim 1, including a co-dopant which exhibits an absorption band in the range 900 to 1100 nm.

11. The dysprosium-doped tellurite or germanate glass as claimed in claim 1, obtainable by melt-quenching a glass composition of oxides and/or halides in the presence of a gas flow.

12. The dysprosium-doped tellurite or germanate glass as claimed in claim 11, wherein the glass composition of oxides and/or halides comprises dysprosium oxide or dysprosium halide, wherein the amount of dysprosium oxide or dysprosium halide in the glass composition of oxides and/or halides is in excess of 1 wt %.

13. The dysprosium-doped tellurite or germanate glass as claimed in claim 1, in the form of a spatially inhomogeneous structure.

14. A laser assembly comprising:
a gain medium composed of a dysprosium-doped tellurite or germanate glass which exhibits a fluorescence peak attributable to the ⁶H_{13/2} to ⁶H_{15/2} transition in the mid-IR sectrum;
an exciter upstream from the gain medium and capable of exciting the gain medium into a mid-IR output; and
a mechanism optically associated with the gain medium to provide optical feedback in the gain medium.

15. Use of a dysprosium-doped tellurite or germanate glass as defined in claim 1, as or in a phosphor or as a gain medium.
